(19) United States
(12) Patent Application Publication
(10) Pub. No.: US 2008/0009529 A1
(43) Pub. Date: Jan. 10, 2008

(54) Methods and compositions for controlling algae

(76) Inventors: Michael D. Netherland, Gainesville, FL (US); Steve D. Cockreham, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/325,667

(22) Filed: Jan. 4, 2006

Related U.S. Application Data
(63) Continuation of application No. 11/122,392, filed on May 5, 2005, now abandoned.
Application No. 11/122,392 is a continuation of application No. 10/502,419, now abandoned.
(60) Provisional application No. 60/351,727, filed on Jan. 24, 2002.

(51) Int. Cl. A01N 43/40; A01P 13/00

(52) U.S. Cl. 514/350

(57) ABSTRACT

Described are preferred methods and compositions for controlling algae which involve the use of bleaching pyridinecarboxamide compounds.

### BACKGROUND

The present invention relates generally to the control of algae in bodies of water such as lakes, ponds and other aqueous systems. In one particular embodiment, the present invention relates to the control of such algae using bleaching pyridinecarboxamide compounds.

As further background, undesirable growth of algal species is a continuing challenge in water bodies such as lakes, ponds and reservoirs. To date, the primary agent used to control such algal species has been copper sulfate. Very few organic compounds have proven successful in this field.

One important issue faced when developing an algicidal agent for use in water bodies is the potential impact the agent may have on native aquatic plants. In many situations, maximal control of algae must be combined with minimal impact on native vascular plants.

In light of this background, there is a continuing need for additional compositions and methods for selectively controlling algae. The present invention addresses this need.

### SUMMARY OF THE INVENTION

It has been discovered that bleaching pyridinecarboxamide compounds can be used with advantage in the selective control of a broad range of algae in bodies of water such as lakes, ponds, reservoirs and the like. Accordingly, one preferred embodiment of the present invention provides a method for the selective control of algae in a body of water containing aquatic plants, comprising the step of providing in the body of water an effective algicidal concentration of a bleaching pyridinecarboxamide compound, and in one particular embodiment picolinafen. In general, methods of the invention will involve maintaining in the body of water a bleaching pyridinecarboxamide compound at a concentration of about 1 ppb to about 80 ppb, more typically about 1 ppb to about 30 ppb. The pyridinecarboxamide compound can be added to the body of water, for example, in liquid formulations. Using the preferred pyridinecarboxamide compounds, for example picolinafen, it has been found that there is substantially no impact upon aquatic plants in the treated body of water. In this regard, native aquatic plants typical to such bodies of water may include one or more of variable leaf pondweed (Potamogeton diversifolious), Illinois pondweed (Potamogeton illinoensis), coontail (Ceratophyllum demeresum), Variable leaf milfoil (Myriophyllum heterophyllum), cone-spur bladderwort (Utricularia gibba). common elodea (Elodea canadensis), spatterdock (Nuphar luteum) and water-lily (Nymphaea spp.).

Preferred pyridinecarboxamide compounds useful in the present invention are encompassed by the general formula: 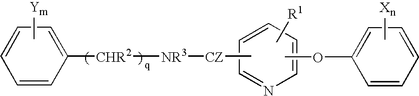
wherein: R¹ is hydrogen, halogen, alkyl or haloalkyl;
R² is hydrogen or alkyl;
R³ is hydrogen, alkyl, or alkenyl;
each X is independently a halogen atom, optionally substituted alkyl or alkoxy, alkenyloxy, alkynyloxy, cyano, carboxy, alkoxycarbony, (alkylthio) carbonyl, alkylcarbonyl, amido, alkylamido, nitro, alkylthio, haloalkylthio, alkenylthio, alkynylthio, alkylsulphinyl, alkylsulphonyl, alkyloximinoalkyl or alkenyloximinoalkyl;
each Y is independently a halogen atom, alkyl,
   nitro,cyano, haloalkyl, alkoxy or haloalkoxy;
Z is an oxygen atom or sulfur atom;
n and m are independently 0 or an integer from 1 to 5; and
q is 0 or 1.
   Particularly preferred among these compounds are the encompassed N-phenyl-4-phenoxy-3-pyridinecarboxamide compounds, N-phenyl-2-phenoxy-3-pyridinecarboxamide compounds, and N-phenyl-2-phenoxy-6-pyridinecarboxamide compounds.

Another preferred embodiment of the invention provides an algicidal concentrate composition for addition to a body of water for algae control, comprising a liquid carrier suitable for introduction into an aquatic environment, and a bleaching pyridinecarboxamide compound at level constituting about 5% to about 90% by weight of the-overall composition, more typically about 10% to about 85% by weight of the overall composition. Such compositions and other compositions for use in methods of the invention can be provided in containers labeled with indicia for algicidal use, including for instance rates of application, etc.

The present invention provides improved and/or alternative methods and compositions for controlling algal growth. Additional features and embodiment of the invention will be apparent from the descriptions herein.

### DESCRIPTION OF THE PREFERRED EMBODIMENTS

For the purposes of promoting an understanding of the principles of the invention, reference will now be made to certain embodiments thereof and specific language will be used to describe the same. It will nevertheless be understood that no limitation of the scope of the invention is thereby intended, such alterations, further modifications and further applications of the principles of the invention as described herein being contemplated as would normally occur to one skilled in the art to which the invention relates.

As disclosed above, it has been discovered that bleaching pyridinecarboxamide compounds can be used to selectively control algae in bodies of water, including such bodies also containing aquatic plants. The present invention thus provides algicidal methods and compositions incorporating the use of such pyridinecarboxamide compounds.

Turning now to a discussion of algicidal agents for use in the invention, generally, they will belong to the class of bleaching pyridinecarboxamide compounds, some of which have been used in the past as herbicidal agents. Preferred bleaching pyridinecarboxamide compounds for use in the invention are encompassed by the formula I: 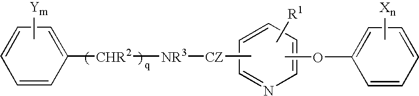
wherein: R¹ is hydrogen, halogen, alkyl or haloalkyl;
R² is hydrogen or alkyl;
R³ is hydrogen, alkyl, or alkenyl;
each X is independently a halogen atom, optionally substituted alkyl or alkoxy, alkenyloxy, alkynyloxy, cyano, carboxy, alkoxycarbony, (alkylthio)carbonyl, alkylcarbonyl, amido, alkylamido, nitro, alkylthio, haloalkylthio, alkenylthio, alkynylthio, alkylsulphinyl, alkylsulphonyl, alkyloximinoalkyl or alkenyloximinoalkyl;
each Y is independently a halogen atom, alkyl,
   nitro,cyano, haloalkyl, alkoxy or haloalkoxy;
Z is an oxygen atom or sulfur atom;.
n and m are independently 0 or an integer from 1 to 5; and
q is 0 or 1.

The term alkyl as used herein in respect of a radical or moiety refers to a straight or branched chain radical or moiety. Suitably an alkyl moiety has from 1 to 6 carbon atoms, preferably from 1 to 4 carbon atoms. A preferred alkyl moiety is an ethyl or, especially, a methyl group and a preferred alkoxy moiety is ethoxy, especially, methoxy.

Unless otherwise noted herein, when an alkyl or alkoxy group is designated as being optionally substituted, the substituent groups which are optionally present may be any of those customarily employed in the development of biocidal compounds, and/or the modification of such compounds to influence their structure/activity, persistence, penetration or other property. Specific examples of such substituents include halogen, especially fluorine, chlorine or bromine atoms, and phenyl, cyano, amino, hydroxy, alkoxy and (alkyl)amino groups, alkyl groups suitably having 1 or 2 carbon atoms. Preferred substituents are halogen, especially fluorine, atoms.

As used herein the term halogen atom may denote a bromine, iodine, chlorine or fluorine atom, and is preferably a chlorine or fluorine atom, most preferably a fluorine atom.

Particularly preferred among the compounds of formula I are the N-phenyl-4-phenoxy-3-pyridine carboxamide compounds, N-phenyl-2-phenoxy-3 -pyridine carboxamide compounds, and N-phenyl-2-phenoxy-6-pyridine carboxamide compounds.

For example, suitable for use in the present invention are the compounds disclosed in U.S. Pat. No. 5,294,597 issued Mar. 15, 1994. Thus, the compounds may be encompassed by the general formula II: 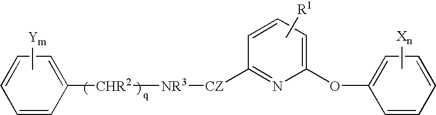
wherein the variables R¹, R², R³, X, Y, q, m, n and Z are as disclosed above. A further preference exists for compounds in which Z is an oxygen atom, m=1, Y,is fluorine (especially where Ym represents 4-flouro), n=1, X is trifluoromethyl (especially where Xₙ represents 3-trifluoromethyl), q=0, and R¹, R², and R³ are hydrogen. For example, a particularly preferred compound for use in the invention is N-(4-fluorophenyl)-6-[3-(trifluoromethyl)phenoxy]-2-pyridinecarboxamide, having the common name picolinafen, which has been discovered to provide unexpected advantages in the selective control of algae in water bodies. Additional disclosures, preferences and preparative details with regard to compounds of the formula II are found in U.S. Pat. No. 5,294,597, which is hereby incorporated herein by reference in its entirety.

Also suitable for use in the present invention are compounds disclosed in U.S. Pat. No. 4,270,946 issued Jun. 2, 1981, U.S. Pat. No. 4,327,218 issued Apr. 27, 1982, and U.S. Pat. No. 4,618,366 issued Oct. 21, 1986, and derivatives thereof. Thus, other compounds for use in the invention will be encompassed by the general formula III: 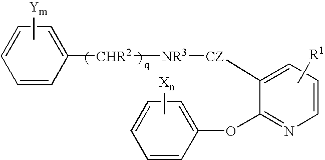
wherein the variables R¹, R², R³, X, Y, q, m, n and Z are as disclosed above. A further preference exists for compounds in which Z is an oxygen atom, m=2, Y is fluorine (particularly where Yₘ represents 2,4-difluoro), n=1, X is trifluoromethyl (especially where Xₙ represents 3-trifluoromethyl), q=0. and R¹, R², and R³ are hydrogen. For example, a particularly preferred compound for use in the invention is N-(2,4-difluorophenyl)-2-[3-(trifluoromethyl)phenoxy]-3-pyridinecarboxamide, having the common name diflufenican. Additional disclosures, preferences and preparative details with regard to compounds of the formula III are found in U.S. Pat. Nos. 4,270,946,. 4,327,218, and 4,618,366, each of which is hereby incorporated herein by reference in its entirety.

The algicidal pyridine carboxamide compound may be applied to the body of water in any suitable fashion. Preferably, the compound will be spray-applied to the body of water, in particular to contact algal mass at the surface of the water where such a mass exists. The algicidal pyridine carboxamide will be applied at a level and for a duration sufficient to control the growth of the algal species involved. In this regard, the level and duration of application may vary in accordance with several factors including the particular body of water to be treated, and susceptibility of the algal species to the algicidal compound. In general, the pyridinecarboxamide compound will be maintained in the body of water at a level of about I part per billion (ppb) to about 80 ppb, more typically in the range of about 1 ppb to about 30 ppb. The duration of the treatment may vary, for example, from several days to several weeks or more.

It will generally be preferred to adopt a treatment regimen whereby the presence of the pyridinecarboxamide compound has no substantial impact upon native vascular plant life associated with the body of water. For example, the treatment may occur in a body of water containing, and have no substantial impact upon, one or more of the following plants: variable leaf pondweed (Potamogeton diversifolious), Illinois pondweed (Potamogeton illinoensis), coontail (Ceratophyllum demeresum). Variable leaf milfoil (Myriophyllum heterophyllum), cone-spur bladderwort (Utricularia gibba). common elodea (Elodea canadensis), spatterdock (Nuphar luteum) and water-lily (Nymphaea spp.). It will be understood that the particular, native vascular plant or plants will vary depending upon the geographic location of the body of water to be treated.

The present invention also provides algicidal compositions that incorporate a bleaching pyridinecarboxamide compound and a carrier suitable for application to an aquatic environment. In particular preferred carriers will be aqueous-based carriers as known in the art. Compositions of the invention may be provided as algicidal concentrate, for example constituted from about 5% to about 90% by weight of the pyridinecarboxamide compound, more typically about 10% to about 85% by weight of the pyridinecarboxamide compound.

Algicidal compositions of and for use in accordance with the invention may be provided in appropriate containers bearing labels or other indicia for algicidal use, including for example typical label features such as suggested rates of application, activities, etc. In this regard, such compositions may be provided as solid or liquid formulations, including for example wettable powders, dusts, granules, solutions, emulsifiable concentrates, emulsions, suspension concentrates or aerosols. In certain forms, in addition to any other carriers included, the compositions may include an ionic or nonionic surfactant suitable for introduction into an aquatic environment, which may for example facilitate the incorporation of the pyridinecarboxamide compound into the body of water to be treated.

It has also been discovered that bleaching pyridinecarboxamide compounds are effective in controlling a broad spectrum of algal species, including for example Scenedesmus and Ankistrodesmus (green phytoplankton), Pithophora and Oedogonium (filamentous green), and Anabaena, Oscilatoria, and Pseudanabaena (blue-green). Such a broad spectrum is important in the use of these compounds has algicides, as a variety of species are encountered in typical water bodies to be treated.

The present invention is applied with advantage to the treatment of water bodies such as lakes, reservoirs, and ponds, where undesirable algal growth is prevalent. As one particular example, relatively small ponds (e.g. of less than about 10 acres) are particularly susceptible to high levels of unwanted algal growth, and can be treated in accordance with the invention. Other water systems susceptible to algal growth may of course also be treated in accordance with the invention.

For the purpose of promoting a further understanding of the present invention and its features and advantages, the following specific Examples are provided. It will be understood that these Examples are illustrative, and not limiting, in nature.

### EXAMPLES

General Methods:

A stock solution of 50 micrograms picolinafen/L was prepared from technical grade picolinafen. Axenic algal cultures of Scenedesmus and Ankistrodesmus (green phytoplankton), Pithophora and oedogonium (filamentous green), and Anabaena, Oscillatoria, and Pseudanabaena (blue-green) were grown. Stock material from these cultures was placed in 250 ml of CLII media (a known, defined algal growth medium). Following the addition of the algae, picolinafen was added to the beakers to achieve concentrations of 0, 1.5, 5, 10, 25, and 50 ppb. Each treatment was replicated three times and beakers were placed in Percival growth chambers that were set at 25° C., with a light intensity of 300 micromoles/square meter/second and a 16:8 photoperiod. The algae were given a 10 to 14 day incubation period, and depending on the growth form of the algae, either total chlorophyll, cell counts, or algal biomass were quantified as end points.

Results:

Data indicate that most algal species were highly sensitive to Picolinofen at concentrations of 10 ppb and less (see e.g. Tables 1-6). As has been noted with other phytoene desaturase (PDS) inhibitors, a threshold concentration is achieved at which increasing concentrations no longer provide enhanced efficacy. Visual observations suggest that activity is rapid with bleaching noticed within 12 hours for some of the test species. Anabaena proved to show the highest level of tolerance to picolinafen when compared to other algal species (Table 4). The Anabaena results may indicate that a longer exposure period may be necessary for this species. Testing of two other blue-green species suggest that this result is more species specific and likely not due to increased tolerance by blue-green algae in general. In addition to the results set forth in Tables 1-6, picolinafen proved to be similarly useful in the control of algal cultures of Pseudanabaena and Pithophora, as shown in Tables 7-8. On the other hand, at levels showing significant control of the algal species, picolinafen was found to have substantially no impact upon the growth of hydrilla or eurasian watermilfoil, evidencing the selectivity for algicidal activity over herbicidal activity in the aquatic environment.

Discussion:

Comparing the response to picolinafen for two aquatic macrophyte species to the response of various algal species evidences that picolinafen has greater algacidal than herbicidal activity in the aquatic environment.

TABLE 1
Impact of Picolinafen on total chlorophyll of Scenedesmus following
a 10-day exposure period to various concentrations.

| Concentration | Total Chl |
|---|---|
| (ppb) | (μg chl/g) |
| Initial values | 128 (13) |
| Untreated | 2238 (104) |
| MeOH Blank | 2097 (86) |
| 1.5 | 2427 (119) |
| 5 | 87 (16) |
| 10 | 15 (6) |
| 25 | 17 (8) |
| 50 | 12 (6) |

TABLE 2
Impact of Picolinafen on algal cell counts of Ankistrodesmus
following a 10-day exposure period to various concentrations.

| Concentration | Cell Count |
|---|---|
| (ppb) | (cells/ml) |
| Initial values | 213,719 |
| Untreated | 5,019,444 |
| MeOH Blank | 4,877,402 |
| 1.5 | 3,025,323 |
| 5 | 141,246 |
| 10 | 96,622 |
| 25 | 87,012 |
| 50 | 81,706 |

TABLE 3
Impact of Picolinafen on total chlorophyll of Anabaena following
a 10-day exposure period to various concentrations.

| Concentration | Total Chl |
|---|---|
| (ppb) | (μg chl.) |
| Initial | 132 |
| Untreated | 926 |
| MeOH Blank | 884 |
| 1.5 | 880 |
| 5 | 906 |
| 10 | 685 |
| 25 | 526 |
| 50 | 101 |

TABLE 4
Impact of Picolinafen on total chlorophyll of Oscillatoria following
a 10-day exposure period to various concentrations.

| Concentration | Total Chl |
|---|---|
| (ppb) | (μg chl.) |
| Initial | 45 |
| Untreated | 582 |
| MeOH Blank | 709 |
| 1.5 | 14 |
| 5 | 10 |
| 10 | 21 |
| 25 | 17 |
| 50 | 13 |

TABLE 5
Impact of Picolinafen on total chlorophyll and
biomass of Oedogonium following a 10-day exposure
period to various concentrations.

| Concentration | Total Chl | Biomass |
|---|---|---|
| (ppb) | (μg chl.) | mg dry wt./beaker |
| Initial | 2292 | 0.007 |
| Untreated | 1141 | 0.067 |
| MeOH Blank | 1079 | 0.066 |
| 1.5 | 1522 | 0.064 |
| 5 | 1057 | 0.027 |
| 10 | 342 | 0.019 |
| 25 | 247 | 0.011 |
| 50 | 144 | 0.005 |

TABLE 6
Impact of Picolinafen on biomass of Spirogyra following
a 10-day exposure period to various concentrations.

| Concentration | Biomass |
|---|---|
| (ppb) | mg dry wt./beaker |
| Initial | 4.6 |
| Untreated | 21.3 |
| MeOH Blank | 20.6 |
| 1.5 | 16.2 |
| 5 | 6.9 |
| 10 | 3.0 |
| 25 | 3.8 |
| 50 | 3.3 |

TABLE 7
Impact of Picolinafin on algal cell counts of
Pseudanabaena (blue-green) following a 10-day
exposure period to various concentrations.

| Concentration | Cell Count |
|---|---|
| (ppb) | (cells/ml) |
| Initial Cell Count | 890 |
| Untreated | 12,511 |
| 1.5 ppb | 2,344 |
| 5 ppb | 89 |
| 10 ppb | 52 |
| 25 ppb | 98 |
| 50 ppb | 77 |

TABLE 8
Impact of Picolinefin on biomass of Pithophora (filamentous green)
following a 10-day exposure period to various concentrations.

| Concentration | Biomass |
|---|---|
| (ppb) | mg dry wt./beaker |
| Initial Biomass | 5.2 |
| Untreated | 25.3 |
| 1.5 ppb | 26.2 |
| 5 ppb | 19.1 |
| 10 ppb | 20.4 |
| 25 ppb | 14.8 |
| 50 ppb | 11.4 |

1. A method for control of algae in a body of water, comprising:
providing in the body of water an effective algicidal concentration of a bleaching pyridinecarboxamide compound.

2. The method of claim 1, comprising maintaining in said body of water a concentration of the compound of about 1 ppb to about 80 ppb.

3. The method of claim 1, wherein said providing includes applying to said body of water an aqueous liquid formulation containing the compound.

4. The method of any of claims 14, wherein said compound is encompassed by the formula I: 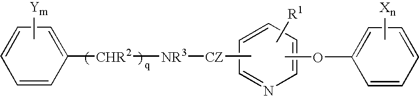
wherein: R¹ is hydrogen, halogen, alkyl or haloalkyl;
R² is hydrogen or alkyl;
R³ is hydrogen, alkyl, or alkenyl;
each X is independently a halogen atom, optionally substituted allyl or alkoxy, alkenyloxy, alkynyloxy, cyano, carboxy, alkoxycarbony, (alkylthio)carbonyl, alkylcarbonyl, amido, alkylamido, nitro, alkylthio, haloalkylthio, alkenylthio, alkynylthio, alkylsulphinyl, alkylsulphonyl, alkyloximinoalkyl or alkenyloximinoalkyl;
each Y is independently a halogen atom, alkyl, nitro,cyano, haloalkyl, alkoxy or haloalkoxy;
Z is an oxygen atom or sulfur atom;
n and m are independently 0 or an integer from 1 to 5; and
q is 0 or 1.

5. The method of claim 4, wherein the compound is picolinafen.

6. A method of claim 4, wherein the compound is encompassed by the general formula II: 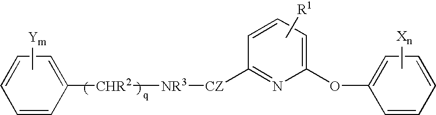
wherein the variables R¹, R², R³, X, Y, q, m, n and Z are as defined in claim 4.

7. A method of claim 4, wherein the compound is encompassed by the general formula III: 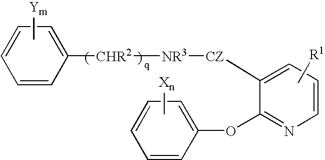
wherein the variables R¹, R², R³, X, Y, q, m, n and Z are defined as in claim 4.

8. A method of claim 7, wherein the compound is diflufenican.

9. An algicidal concentrate composition for addition to a body of water for algae control, comprising:
a liquid carrier suitable for introduction into an aquatic environment; and
a bleaching pyridinecarboxamide compound at a level constituting about 5% to about 90% of said concentrate composition.

10. The algicidal concentrate composition of claim 9, wherein said compound is encompassed by the formula I: 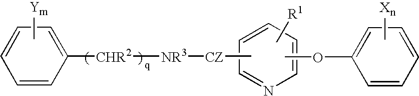
wherein: R¹ is hydrogen, halogen, alkyl or haloalkyl;
R² is hydrogen or alkyl;
R³ is hydrogen, alkyl, or alkenyl;
each X is independently a halogen atom, optionally substituted alkyl or alkoxy, alkenyloxy, alkynyloxy, cyano, carboxy, alkoxycarbony, (alkylthio)carbonyl, alkylcarbonyl, amido, alkylamido, nitro, alkylthio, haloalkylthio, alkenylthio, alkynylthio, alkylsulphinyl, alkylsulphonyl, alkyloximinoalkyl or alkenyloximinoalklyl;
each Y is independently a halogen atom, alkyl, nitro,cyano, haloalkyl, alkoxy or haloalkoxy;
Z is an oxygen atom or sulfur atom;
n and m are independently 0 or an integer from 1 to 5; and
q is 0 or 1.

11. The composition of claim 10, wherein said compound is picolinafen.

12. The composition of claim 9, wherein the compound is encompassed by the general formula II: 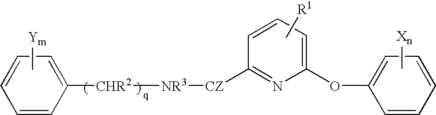
wherein the variables R¹, R², R³, X, Y, q, m, n and Z are defined as in claim 9.

13. The composition of claim 9, wherein the compound is encompassed by the general formula III: 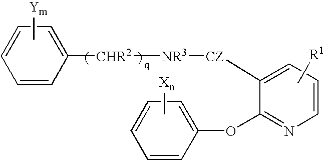
wherein the variablesR,R2,R3, X, Y, q, m, n and Z are as defined in claim 9.

14. The composition of claim 13, wherein the compound is diflufenican.

15. A product, comprising: a container; a composition in said container, the composition including a bleaching pyridinecarboxamide compound; said container bearing visible indicia regarding algicidal use of the composition.

16. The product of claim 15, wherein said compound is encompassed by the formula I: 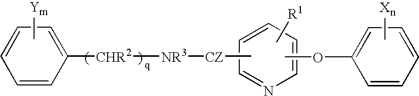
wherein: R¹ is hydrogen, halogen, alkyl or haloalkyl;
R² is hydrogen or alkyl;
R³ is hydrogen, alkyl, or alkenyl;
each X is independently a halogen atom, optionally substituted alkyl or alkoxy, alkenyloxy, alkynyloxy, cyano, carboxy, alkoxycarbony, (alkylthio) carbonyl, alkylcarbonyl, amido, alkylamido, nitro, alkylthio, haloalkylthio, alkenylthio, alkynylthio, alkylsulphinyl, alkylsulphonyl, alkyloximinoalkyl or alkenyloximinoalkyl;
each Y is independently a halogen atom, alkyl,
nitro, cyano, haloalkyl, alkoxy or haloalkoxy;
Z is an oxygen atom or sulfur atom;
n and m are independently 0 or an integer from 1 to 5; and
q is 0 or 1.

17. The product of claim 16, wherein said compound is picolinafen.

18. The product of claim 16, wherein the compound is encompassed by the general formula II: 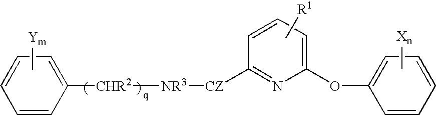
wherein the variables R¹, R², R³, X, Y, q, m, n and Z are as defined in claim 16.

19. The product of claim 16, wherein the compound is encompassed by the general formula III: 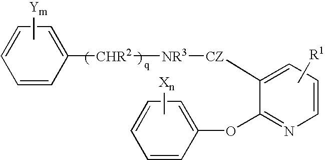
wherein the variables R¹, R², R³, X, Y, q, m, n and Z are as defined in claim 16.

20. The product of claim 19, wherein the compound is diflufenican.
